(19) United States
(12) Patent Application Publication
(10) Pub. No.: US 2025/0178338 A1
(43) Pub. Date: Jun. 5, 2025

(54) PRINTING DEVICE THAT EXECUTES PERIODIC CLEANING, METHOD OF CONTROLLING SAME, AND STORAGE MEDIUM

(71) Applicant: CANON KABUSHIKI KAISHA, Tokyo (JP)

(72) Inventor: RYUJI YAMANAKA, Tokyo (JP)

(21) Appl. No.: 18/965,837

(22) Filed: Dec. 2, 2024

(30) Foreign Application Priority Data
Dec. 5, 2023 (JP) 2023-205197

(51) Int. Cl. B41J 2/045; B41J 2/165

(52) U.S. Cl. CPC B41J 2/0451; B41J 2/04573; B41J 2/16505; B41J 2/16579; B41J 2/04586

(57) ABSTRACT

A printing device that cleans print heads provided with a nozzle for ejecting ink and executes periodic cleaning when accumulated printing time as printing time accumulated from the latest execution of cleaning reaches a first threshold value. The accumulated printing time obtained by accumulating printing time is counted. When there is a job break point involving printing interruption in a case where there are a plurality of print jobs that can be continuously printed in a time width of the accumulated printing time in which the counted accumulated printing time is less than a first threshold value and is greater than or equal to a second threshold value less than the first threshold value, the periodic cleaning is executed at the job break point by advancing timing of execution of the periodic cleaning.

### BACKGROUND

### Field of the Disclosure

The present disclosure relates to a printing device that executes periodic cleaning when an accumulated printing time reaches a predetermined threshold value in a configuration that cleans print heads equipped with a nozzle for ejecting ink, a method of controlling the same, and a storage medium.

### Description of the Related Art

Conventionally, in an image forming apparatus that forms an image by ejecting ink, to keep good print quality, a method of executing periodic cleaning in a case where a printing time accumulated from the latest execution of cleaning satisfies a predetermined condition is employed. For example, Japanese Laid-Open Patent Publication (Kokai) No. 2023-4093 discloses a method of executing cleaning in a case where accumulated printing time reaches a predetermined time before printing is started or after the printing is finished. Japanese Laid-Open Patent Publication (Kokai) No. 2021-30595 discloses a method in which when the accumulated printing time reaches a predetermined time or more, during printing, the printing is temporarily interrupted, and cleaning is executed.

In the method disclosed in Japanese Laid-Open Patent Publication (Kokai) No. 2023-4093, since the timing of periodic cleaning is limited to the timing before printing is started and the timing after the printing is finished, in a case where it takes a long time to perform printing, it is difficult to execute periodic cleaning at a preferable timing. That is, in a case where cleaning is performed before printing is started, there is a concern that execution of cleaning is too early (in other words, an execution interval is too short), and an amount of ink consumed by cleaning is increased. In a case where cleaning is performed after the printing is finished, there is a concern that execution of cleaning is too late (in other words, an execution interval is too long), and it is impossible to keep the good print quality.

In the method disclosed in Japanese Laid-Open Patent Publication (Kokai) No. 2021-30595, since printing is temporarily interrupted to execute cleaning, downtime is generated every time due to execution of periodic cleaning.

### SUMMARY

The present disclosure provides a printing device that enables reducing downtime while suppressing the amount of ink consumed by cleaning, a method of controlling the same, and a storage medium.

In a first aspect of the present disclosure, a printing device configured to clean print heads provided with a nozzle for ejecting ink and execute periodic cleaning when accumulated printing time as printing time accumulated from the latest execution of cleaning reaches a first threshold value includes at least one processor and at least one memory, in communication with the at least one processor, storing a program that, when executed by the processor, cause the processor to count accumulated printing time obtained by accumulating printing time, and execute, when there is a job break point involving printing interruption in a case where there are a plurality of print jobs that can be continuously printed in a time width of the accumulated printing time in which the counted accumulated printing time is less than the first threshold value and is greater than or equal to a second threshold value less than the first threshold value, the periodic cleaning at the job break point by advancing timing of execution of the periodic cleaning.

In a second aspect of the present disclosure, a method of controlling a printing device configured to clean print heads provided with a nozzle for ejecting ink and execute periodic cleaning when accumulated printing time as printing time accumulated from the latest execution of cleaning reaches a first threshold value that includes counting accumulated printing time obtained by accumulating printing time, and executing, when there is a job break point involving printing interruption in a case where there are a plurality of print jobs that can be continuously printed in a time width of the accumulated printing time in which the counted accumulated printing time is less than the first threshold value and is greater than or equal to a second threshold value less than the first threshold value, the periodic cleaning at the job break point by advancing timing of execution of the periodic cleaning.

According to the present disclosure, it is possible to reduce downtime while suppressing the amount of ink consumed by cleaning.

Further features of the present disclosure will become apparent from the following description of exemplary embodiments with reference to the attached drawings.

### BRIEF DESCRIPTION OF THE DRAWINGS

FIG. 1 is a configuration diagram of an image forming system.

FIG. 2 is a functional configuration diagram of the image forming system.

FIGS. 3A and 3B are flowcharts of a periodic cleaning advanced execution timing determination process.

FIG. 4 is a flowchart of a process for determining whether or not jobs can be continuously printed.

FIG. 5 is a flowchart of an inter-job interruption time calculation process.

FIG. 6 is a table useful in explaining an example of an inter-job interruption factor, necessary processing, and a time required to execute the necessary processing.

FIG. 7 illustrates a diagram of a print start confirmation screen displayed on a user interface (UI) console panel.

FIGS. 8A and 8B are flowcharts of a print process.

FIGS. 9A and 9B are diagrams illustrating an example of scheduling of advanced execution of cleaning.

FIGS. 10A and 10B are flowcharts of a periodic cleaning advanced execution timing determination process in a second embodiment.

FIGS. 11A and 11B are flowcharts of a print process in the second embodiment.

FIGS. 12A and 12B are schematic diagrams illustrating an example of scheduling of advanced execution of the periodic cleaning in the second embodiment.

FIGS. 13A and 13B are flowcharts of a print process in a third embodiment.

FIG. 14 is a schematic diagram of a time schedule in a case where print process in the third embodiment is executed in the third embodiment.

### DESCRIPTION OF THE EMBODIMENTS

The present disclosure will now be described in detail below with reference to the accompanying drawings showing embodiments thereof. The following description of the configuration of the embodiments is provided by way of example, and the scope of the present disclosure is not limited to the described configuration of the embodiments.

A first embodiment of the present disclosure will be described. Note that the same components and processes are denoted by the same reference numerals. In the present embodiment, an image forming system 200 will be described as an example of a printing device. In the first embodiment, a description will be provided of an aspect in which cleaning is advanced and executed at an interruption timing between print jobs with reference to the drawings.

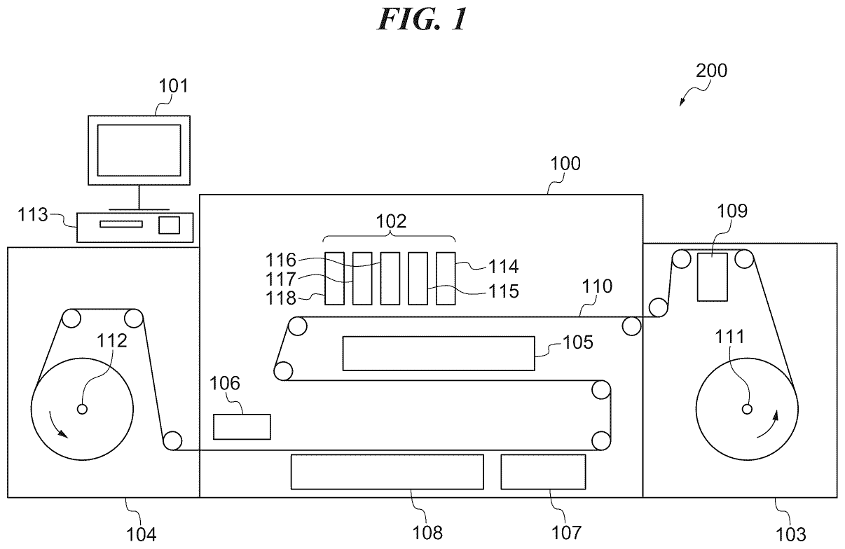

FIG. 1 is a configuration diagram of the image forming system 200 according to the first embodiment. The image forming system 200 includes a sheet feeding device 103, an image forming apparatus 100, a sheet discharging device 104, a UI console panel 101, and a control personal computer (PC) 113. The image forming system 200 forms an image on a continuous sheet (hereinafter also referred to as the “roll sheet”) 110 as a roll-shaped recording medium used in the present embodiment, on which continuous image formation can be performed.

The sheet feeding device 103 supplies the roll sheet 110 to the image forming apparatus 100. The sheet feeding device 103 rotates a paper tube of the roll sheet 110 about a rotational shaft 111 and conveys the roll sheet 110 wound around the paper tube toward the image forming apparatus 100 at a constant speed via a plurality of rollers (such as a conveying roller and a sheet feed roller). The upper part of the sheet feeding device 103 is provided with a skew correction device 109 for properly changing a paper passing direction of the roll sheet 110.

The sheet discharging device 104 discharges the roll sheet 110 from the image forming system 200. The sheet discharging device 104 takes up the roll sheet 110 conveyed from the image forming apparatus 100 by rotating a rotational shaft 112 at a constant speed via a plurality of rollers (such as a conveying roller and a discharge roller) as a product of the roll sheet 110. In the sheet discharging device 104, the roll sheet 110 is wound around a paper tube of the rotational shaft 112 and stored in a rolled state. Before the start of printing, the roll sheet 110 is passed from the sheet feeding device 103 to the sheet discharging device 104 via a predetermined position in the image forming apparatus 100. Specifically, the roll sheet 110 is attached to the sheet feeding device 103, and the roll sheet 110 attached to the sheet feeding device 103 is sequentially passed under a printer 102 provided in the image forming apparatus 100 via the skew correction device 109.

The image forming apparatus 100 has print heads 114 to 118 associated with a plurality of basic print colors (CMYK), respectively, and prints the respective basic print colors (CMYK). The print heads 114 to 118 are the print heads of primer liquid, black, cyan, magenta, and yellow, respectively. The print heads 114 to 118 of the respective basic print colors print characters, an image, and so forth, on the roll sheet 110. In each print head, a lot of nozzles are arranged, and an image is printed by ejecting ink from the nozzles to the roll sheet 110. The roll sheet 110 is further passed under a drying device 105 and over cooling devices 107 and 108 and sequentially passed under a connected scanner device 106. Then, the roll sheet 110 is wound around the rotational shaft 112 of the sheet discharging device 104. When accumulated printing time obtained by accumulating printing time from the latest execution of cleaning reaches a predetermined threshold value (first threshold value), periodic cleaning is executed with respect to each print head.

When printing is performed, after the roll sheet 110 is passed into the image forming apparatus 100, an image formation job (hereinafter simply referred to as the “print job” or “job”) is input to the control PC 113 of the image forming system 200. After the print job is input, printing is started based on an operation of selecting a print start button on the UI console panel 101.

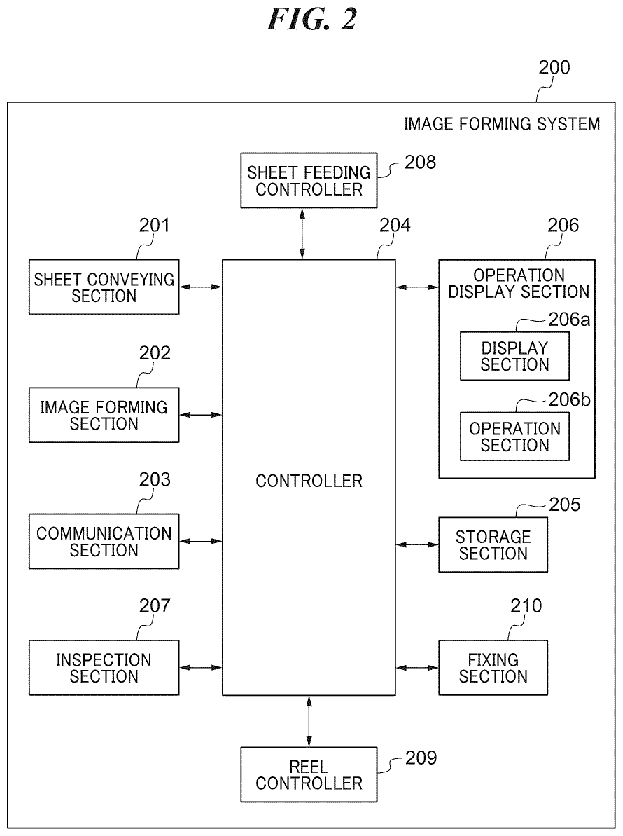

FIG. 2 is a functional configuration diagram of the image forming system 200. The image forming system 200 includes a sheet conveying section 201, an image forming section 202, a communication section 203, a controller 204, a storage section 205, an operation display section 206, an inspection section 207, a sheet feeding controller 208, a reel controller 209, and a fixing section 210.

The controller 204 controls the components connected thereto. The controller 204 is formed by a central processing unit (CPU), a random access memory (RAM), a read only memory (ROM), and so forth. The CPU of the controller 204 reads a variety of programs, such as a system program and a processing program, which are stored in the storage section 205, loads the read programs into the RAM, and executes a variety processing operations based on the loaded programs. With this, desired control and processing are realized. The controller 204 can, for example, perform an image formation process for executing a print job based on a user's instruction.

The communication section 203 is implemented by a communication control card, such as a local area network (LAN) card, and transmits and receives a variety of data to and from an external apparatus connected to a communication network, such as a LAN or a wide area network (WAN). The external apparatus with which the communication section 203 communicates is, for example, the control PC 113.

The storage section 205 is implemented, for example, by a nonvolatile semiconductor memory (such as a flash memory), or a hard disk drive (HDD). The storage section 205 stores the variety of programs executed by the controller 204, including the system program and the processing program, a variety of data necessary for execution of these programs, and so forth.

The operation display section 206 is implemented, for example, by a touch-panel type liquid crystal display (LCD) and includes a display section 206a and an operation section 206b. The display section 206a displays a variety of information items on a display screen of the UI console panel 101 based on a display control signal output from the controller 204. The operation section 206b includes a variety of operation keys, such as numeric keys and a start key, receives a variety of input operations performed by a user, and outputs an operation signal to the controller 204. The operation display section 206 is used, for example, for setting job information, when a print job is executed. The user can set necessary conditions, such as a sheet to be used, printing speed information, the number of sheets to be printed, the number of copies, a print length, a print weight, and a print diameter, as desired, by operating the operation display section 206.

The inspection section 207 performs check control of a printing state of the printer. The inspection section 207 causes the image forming apparatus 100 to print a pattern for ejection failure inspection, and causes the scanner device 106 to read a result of printing the inspection pattern to check whether an ejection failure occurs in the image forming apparatus 100. In a case where the inspection section 207 detects an ejection failure, the inspection section 207 sends information indicating the ejection failure to the controller 204. As the method of inspecting an ejection failure and the like, not only the method of printing an inspection pattern and reading the printed inspection pattern using the scanner, but also a variety of methods can be used, such as a method of inspecting a failure by directly reading a printed image using a camera or a scanner, and a method of monitoring an ejection state of each nozzle. In the present embodiment, whether an ejection failure occurs is checked using the method of printing an inspection pattern and reading the printed inspection pattern using the scanner.

The sheet feeding controller 208 controls sheet feeding of the roll sheet 110 by the sheet feeding device 103. The reel controller 209 controls discharging of the roll sheet 110 by the sheet discharging device 104. The fixing section 210 controls the drying device 105 and the cooling devices 107 and 108 to fix ink by drying and cooling the roll sheet 110 having passed through the image forming apparatus 100. The sheet conveying section 201 has a function of conveying the roll sheet 110, and the image forming section 202 performs a printing operation.

A description will now be provided of the operation performed in a case where the image formation process is performed on the roll sheet 110 in the image forming system 200. First, a user generates data of a print job in an external apparatus, makes print settings of the print job, a setting of the number of rolls to be delivered, and so forth, and then transmits the print job data and the setting information to the image forming system 200 via the communication network. The controller 204 receives the print job data and a job ticket including print setting information of the print job, the information on the number of rolls to be delivered, and so forth, which are transmitted from the external apparatus via the communication section 203. The controller 204 starts the printing operation based on the received information. The controller 204 drives the sheet conveying section 201, the sheet feeding controller 208, and the reel controller 209 to convey the roll sheet 110 in the image forming system 200 and controls the image forming section 202 to perform the printing operation based on the print data.

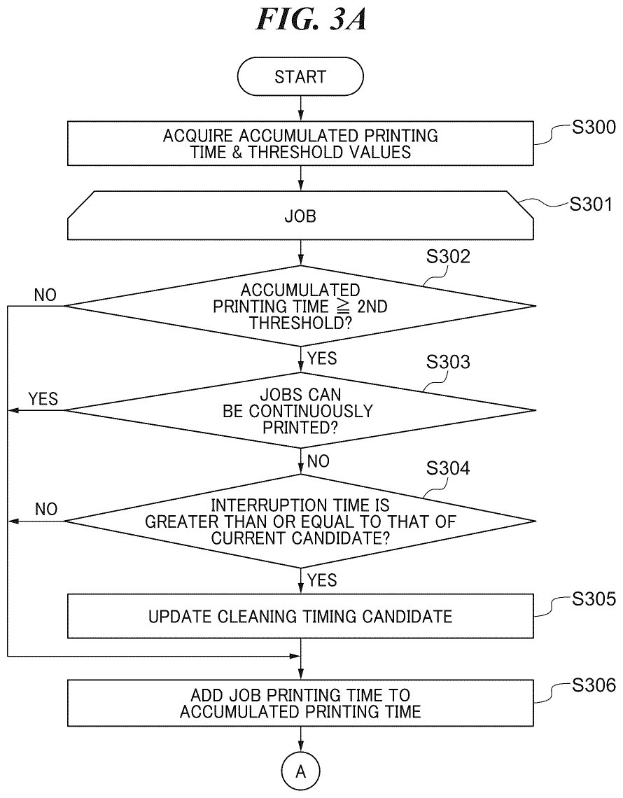

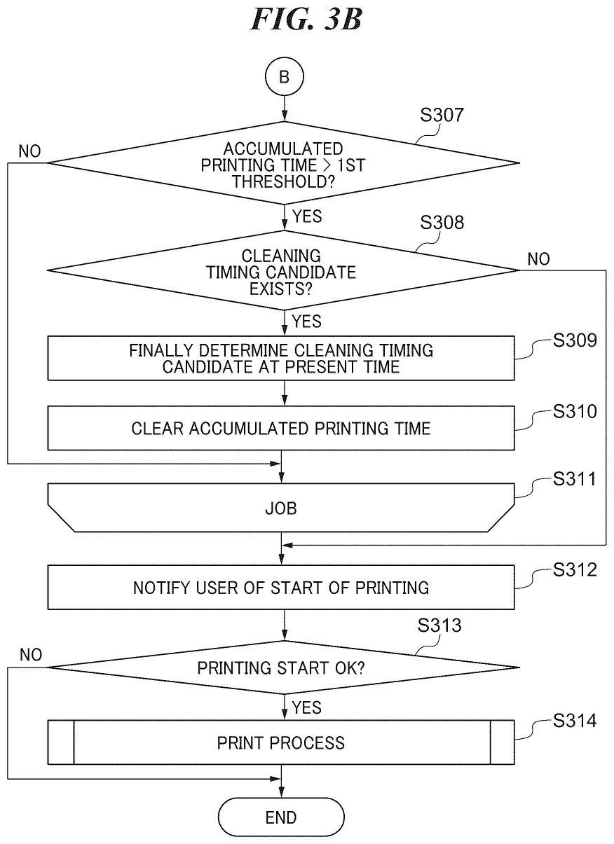

FIGS. 3A and 3B are flowcharts of a periodic cleaning advanced execution timing determination process. The present process is executed when a user selects a job to be printed on the UI console panel 101 and selects the print start button. Steps in FIGS. 3A and 3B are realized by the CPU of the controller 204 of the image forming apparatus 100, which reads a program stored in the storage section 205, loads the read program into the RAM, and executes the loaded program. Alternatively, part or all of steps in FIGS. 3A and 3B can be realized by hardware, such as an application specific integrated circuit (ASIC) and an electronic circuit.

First, in step S300, the controller 204 reads accumulated printing time at the present time point from the storage section 205 into the RAM of the controller 204. The controller 204 reads the first threshold value and a second threshold value, which are used for determination on execution of cleaning from the storage section 205, into the RAM of the controller 204. The accumulated printing time read into the RAM is a temporary value used for determining advanced execution of the periodic cleaning.

The accumulated printing time reflects a total time (accumulated time) of the printing time, which is counted after cleaning was performed last time. The printing time refers to a time period required to perform the print processing operation based on print contents instructed from a user. The accumulated printing time is calculated by counting time required to perform the print processing operation. Specifically, counting is started when head caps attached to prevent ink from being dried are removed from the print heads and is stopped when the head caps are attached to the print heads at the end of printing. Therefore, waiting time between printing operations, a preparation time from the receipt of a print instruction to the start of printing, and so forth are not included in the accumulated printing time. Time for removing the head caps from the print heads e.g. due to cleaning processing is not included in the accumulated printing time. The accumulated printing time is reset whenever cleaning processing is executed. The first threshold value reflects a value of the accumulated printing time for performing the periodic cleaning. When it is detected that the accumulated printing time has reached the first threshold value, the controller 204 instructs the image forming section 202 to perform cleaning of the printer 102. For example, if the apparatus is configured to perform the periodic cleaning whenever the accumulated printing time reaches 3 hours, the first threshold value is set to 3 hours.

The second threshold value is less than the first threshold value and reflects a start time of an advanced execution section that enables advanced execution of the periodic cleaning. For example, in a case where advanced execution of the periodic cleaning is enabled after accumulated printing time of 2 hours 30 minutes is reached, the second threshold value is set to 2 hours 30 minutes. If the difference between the first threshold value and the second threshold value is reduced, the possibility that advanced execution of the periodic cleaning is performed becomes low, but the ink consumption amount is suppressed due to constant execution of cleaning at intervals close to the first threshold value. If the difference between the first threshold value and the second threshold value is increased, while the possibility that advanced execution of the periodic cleaning is performed becomes high, cleaning can be executed much earlier than a time at which the accumulated printing time reaches the first threshold value, which can cause an increased amount of ink consumption. Therefore, it is preferable to properly set the interval between the two threshold values based on the model of the image forming system 200 and the like.

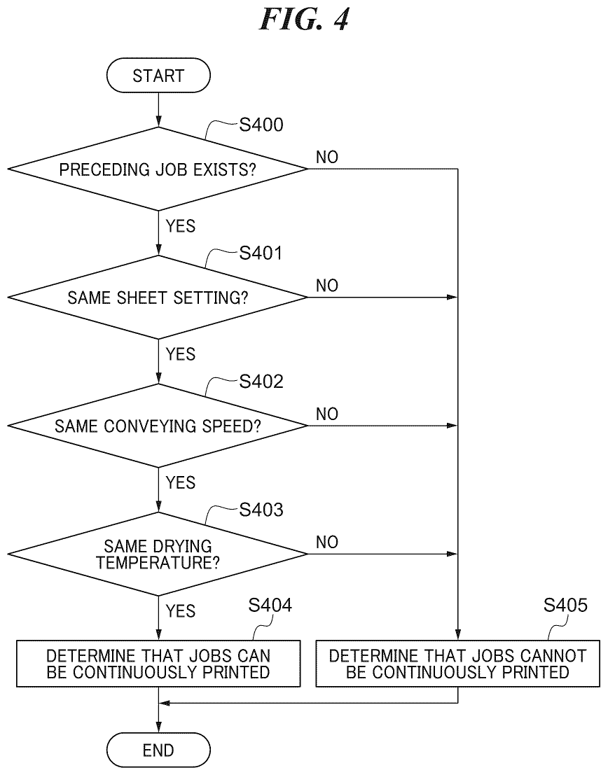

Steps S301 and S311 in FIGS. 3A and 3B indicate that processing operations (steps) between them loop the number of times corresponding to the number of print jobs instructed from a user. In this loop, advanced execution of the periodic cleaning is scheduled. In step S302, the controller 204 determines whether the accumulated printing time stored in the RAM is greater than or equal to the second threshold value. If it is determined by the controller 204 that the accumulated printing time is greater than or equal to the second threshold value (YES in S302), the process proceeds to step S303, whereas if it is determined that the accumulated printing time is less than the second threshold value (NO in S302), the process proceeds to step S306. Next, in step S303, the controller 204 determines whether the immediately preceding job (hereinafter referred to as the “preceding job”) and a currently targeted job (hereinafter referred to as the “current job”) can be continuously printed. If it is determined by the controller 204 that the jobs can be continuously printed (YES in S303), the process proceeds to step S306. If it is determined by the controller 204 that the jobs cannot be continuously printed and printing is to be temporarily stopped between the jobs (NO in S303), the process proceeds to step S304. In a case where the current job is the first job as well, the process proceeds to step S304. A process for determining whether the preceding job and the current job can be continuously printed will now be described with reference to FIG. 4.

FIG. 4 is a flowchart of the process performed in the present embodiment for determining whether the jobs can be continuously printed. The present process is executed when determining in step S303 in FIGS. 3A and 3B whether the preceding job and the current job can be continuously printed. In step S400, the controller 204 determines whether a preceding job exists, i.e. the current job is the first job. If it is determined by the controller 204 that a preceding job exists (YES in S400), the process proceeds to step S401. If it is determined that no preceding job exists (NO in S400), the process proceeds to step S405. Next, in step S401, the controller 204 determines whether the preceding job and the current job are the same in the sheet setting. If it is determined by the controller 204 that the preceding job and the current job are the same in the sheet setting (YES in S401), the process proceeds to step S402. If it is determined that the preceding job and the current job are different in the sheet setting (NO in S401), the process proceeds to step S405.

In step S402, the controller 204 determines whether the preceding job and the current job are the same in the conveying speed setting. If it is determined by the controller 204 that the preceding job and the current job are the same in the conveying speed setting (YES in S402), the process proceeds to step S403. If it is determined that the preceding job and the current job are different in the conveying speed setting (NO in S402), the process proceeds to step S405. In step S403, the controller 204 determines whether the preceding job and the current job are the same in the drying temperature setting. If it is determined by the controller 204 that the preceding job and the current job are the same in the drying temperature setting (YES in S403), the process proceeds to step S404. If it is determined that the preceding job and the current job are different in the drying temperature setting (NO in S403), the process proceeds to step S405.

In step S404, the controller 204 determines that the preceding job and the current job can be continuously printed, followed by terminating the present process. In step S405, the controller 204 determines that the preceding job and the current job cannot be continuously printed, followed by terminating the present process.

Referring back to FIGS. 3A and 3B, in step S304, the controller 204 calculates an inter-job interruption time between the current job and the preceding job and executes the following determination: the controller 204 determines whether the calculated inter-job interruption time is greater than or equal to an inter-job interruption time of a periodic cleaning advanced execution timing candidate (hereinafter referred to as the “current candidate”) as a candidate of advanced execution timing of the periodic cleaning at the present time point. If it is determined by the controller 204 that the calculated inter-job interruption time is greater than or equal to the inter-job interruption time of the current candidate (YES in S304), the process proceeds to step S305. In a case where no current candidate exists, the process proceeds to step S305. If it is determined by the controller 204 that the calculated inter-job interruption time is less than the inter-job interruption time of the current candidate (NO in S304), the process proceeds to step S306. The inter-job interruption time refers to time required in a case where printing is interrupted between jobs (between the preceding job and the current job) and necessary processing is performed. The controller 204 calculates the inter-job interruption time by checking an apparatus state and comparing the print settings between the two jobs.

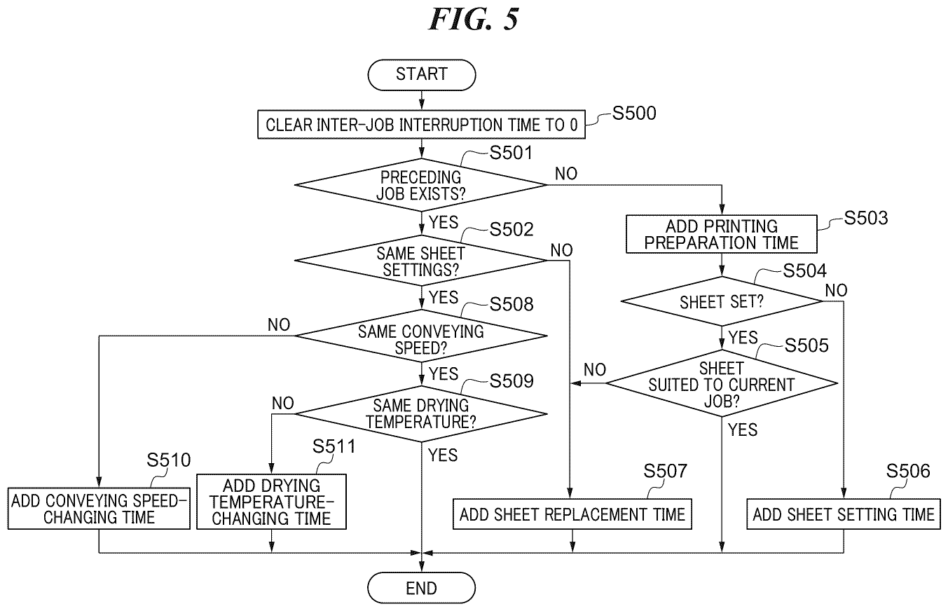

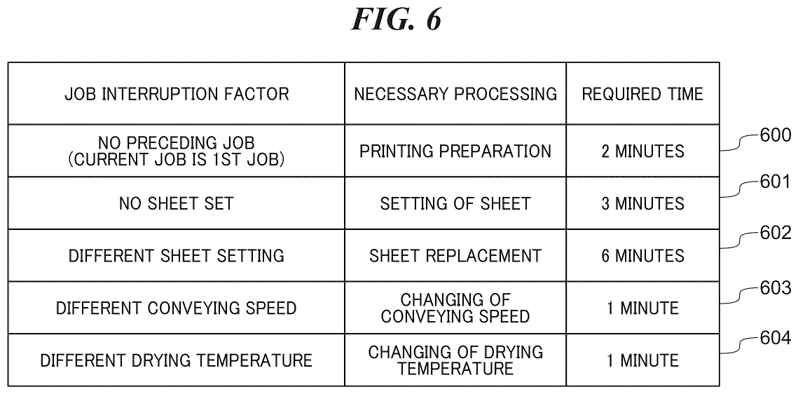

FIG. 5 is a flowchart of an inter-job interruption time calculation process performed in the present embodiment. The present process is executed when calculating the inter-job interruption time between the preceding job and the current job in step S304 in FIGS. 3A and 3B. FIG. 6 is a table illustrating an interruption factor of printing between jobs (inter-job interruption factor), necessary processing, and time required to execute the necessary processing, in an associated state, in the present embodiment. In the present embodiment, the table is stored in the storage section 205 in a table form and is used for calculating the inter-job interruption time.

First, in step S500, the controller 204 initializes (clears) the inter-job interruption time to 0. Next, in step S501, the controller 204 determines whether a preceding job exists, i.e. whether the current job is the first job. If it is determined by the controller 204 that a preceding job exists (YES in S501), the process proceeds to step S502, whereas if it is determined that no preceding job exists (NO in S501), the process proceeds to step S503. In step S503, the controller 204 adds a time (denoted in 600 in FIG. 6) required to perform print preparation for the whole apparatus to the inter-job interruption time. In the illustrated example in FIG. 6, the inter-job interruption factor is absence of the preceding job, and hence two minutes (denoted in 600 in FIG. 6) is added to the inter-job interruption time.

Next, in step S504, the controller 204 determines whether the roll sheet 110 has been set in the sheet feeding device 103. If it is determined by the controller 204 that the roll sheet 110 has been set in the sheet feeding device 103 (YES in S504), the process proceeds to step S505. If it is determined that the roll sheet 110 has not been set in the sheet feeding device 103 (NO in S504), the process proceeds to step S506. In step S506, the controller 204 adds a minimum time (denoted in 601 in FIG. 6) required by the user to set the roll sheet 110 in the sheet feeding device 103 to the inter-job interruption time, followed by terminating the present process. In the illustrated example in FIG. 6, three minutes is added as the time required to set the sheet to the inter-job interruption time.

In step S505, the controller 204 determines whether the roll sheet 110 suited to the sheet setting of the current job has been set in the sheet feeding device 103. If it is determined by the controller 204 that the roll sheet 110 suited to the sheet setting of the current job has been set (YES in S505), the controller 204 terminates the present process. If it is determined that the roll sheet 110 suited to the sheet setting of the current job has not been set in the sheet feeding device 103 (NO in S505), the process proceeds to step S507. In step S505, the controller 204 adds a minimum time (denoted in 602 in FIG. 6) required by the user to replace the roll sheet 110 set in the sheet feeding device 103 to the inter-job interruption time, followed by terminating the present process. In the illustrated example in FIG. 6, six minutes is added as the time required to replace the sheet to the inter-job interruption time.

In step S502, the controller 204 determines whether the preceding job and the current job are the same in the sheet setting. If it is determined by the controller 204 that the preceding job and the current job are the same in the sheet setting (YES in S502), the process proceeds to step S508. If it is determined that the preceding job and the current job are different in the sheet setting (NO), the process proceeds to step S507. In step S508, the controller 204 determines whether the preceding job and the current job are the same in the conveying speed setting. If it is determined by the controller 204 that the preceding job and the current job are the same in the conveying speed setting (YES in S508), the process proceeds to step S509. If it is determined that the preceding job and the current job are different in the conveying speed setting (NO), the process proceeds to step S510. In step S510, the controller 204 adds a conveying speed-changing time (denoted in 603 in FIG. 6) required by the sheet conveying section 201 to change the conveying speed to the inter-job interruption time, followed by terminating the present process. In the illustrated example in FIG. 6, one minute is added as the time required to change the conveying speed to the inter-job interruption time.

In step S509, the controller 204 determines whether the preceding job and the current job are the same in the drying temperature setting. If it is determined by the controller 204 that the preceding job and the current job are the same in the drying temperature setting (YES in S509), the controller 204 terminates the present process. If it is determined that the preceding job and the current job are different in the drying temperature setting (NO in S509), the process proceeds to step S511. In step S511, the controller 204 adds a drying temperature-changing time (denoted in 604 FIG. 6) required by the fixing section 210 to change the drying temperature to the inter-job interruption time, followed by terminating the present process. In the illustrated example in FIG. 6, one minute is added as the time required to change the drying temperature to the inter-job interruption time.

Referring back to FIGS. 3A and 3B, in step S305, the controller 204 executes processing for updating the cleaning timing candidate. That is, the controller 204 sets a timing between the current job and the preceding job as the “current candidate”. In doing this, the controller 204 sets, in a case where the current candidate already exists, the current candidate by overwriting the current candidate. Next, in step S306, the controller 204 calculates the printing time of the current job and adds the calculated printing time to the accumulated printing time stored in the RAM. The printing time of the print job can be calculated by the following equation (1) based on the job setting. For example, assuming that the print length of the job is 500 (m), and the printing speed of the job is 20 (m) per minute, the printing time of the job is 25 (minutes):

$$Job printing time = job print length / job printing speed \qquad ( 1 )$$

In step S307, the controller 204 determines whether the accumulated printing time stored in the RAM exceeds the first threshold value. If it is determined by the controller 204 that the accumulated printing time exceeds the first threshold value (YES in S307), the process proceeds to step S308. If it is determined that the accumulated printing time does not exceed the first threshold value (NO in S307), the process proceeds to S311.

In step S308, the controller 204 determines whether the current candidate set in step S305 exists. If it is determined by the controller 204 that the current candidate exists (YES in S308), the process proceeds to step S309, whereas if it is determined that the current candidate does not exist (NO in S308), the process proceeds to step S312. In step S309, the controller 204 finally determines the current candidate as the cleaning timing candidate at the present time point and overwrites the current candidate. Note that by finally determining the cleaning timing candidate, the execution order and the execution time information of cleaning are finally determined.

Next, in step S310, the controller 204 clears the accumulated printing time on the RAM to 0. This is the last step of the loop indicated by S301 and S311. After the loop, in step S312, the controller 204 sends a display control signal for notifying the user of the start of printing, to the display section 206a. The display section 206a performs display processing based on the received display control signal. At this time, the controller 204 sends the print jobs, and the execution order and the execution time information, which are finally determined in step S309, to the display section 206a. In response to this, the display section 206a displays print jobs, the execution order and the execution time information of cleaning. Note that in the present embodiment, the notification is provided by displaying the notification.

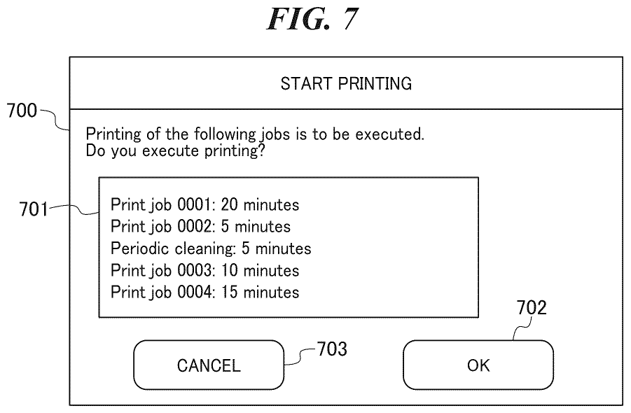

FIG. 7 illustrates a diagram a screen displayed when the start of printing is notified to the user in step S312 in FIGS. 3A and 3B. The description with reference to FIG. 7 is provided assuming a popup screen, but the display screen is not necessarily limited to the display form of the popup screen.

In step S312, when notifying the user of the start of printing, the UI console panel 101 displays a print start confirmation screen 700 illustrated in FIG. 7. On the print start confirmation screen 700, print jobs, the execution order of cleaning, which is finally determined in step S309, and the required time periods, are displayed (as illustrated in 701 in FIG. 7). In the lower part of the print start confirmation screen 700, an OK button 702 and a cancel button 703 are displayed, and these buttons can be selected (subjected to touch operation) at any time.

In an area denoted by reference numeral 701 in FIG. 7, the print jobs and the periodic cleaning are scheduled in the order of print job 0001, print job 0002, periodic cleaning, print job 0003, and print job 0004, and time required to perform each processing is displayed in an associated state.

Referring back to FIGS. 3A and 3B, in step S313, the controller 204 determines whether printing has been started. Specifically, the controller 204 determines whether an operation of selecting the OK button 702 has been detected or an operation of pressing the cancel button 703 has been detected. If it is determined by the controller 204 that the operation of selecting the OK button 702 has been detected (YES in S313), the process proceeds to step S314. If it is determined that the operation of selecting the cancel button 703 has been detected (NO in S313), the present process is terminated. That is, in a case where the controller 204 detects the operation of the OK button 702, the controller 204 provides a display control instruction to the display section 206a to close the print start confirmation screen 700 and proceeds to step S314. When the controller 204 detects the operation of the cancel button 703, the controller 204 provides a display control instruction to the display section 206a to close the print start confirmation screen 700 and terminates the present process.

In step S314, the controller 204 provides a print instruction to the sheet conveying section 201, the image forming section 202, and the fixing section 210 to execute a print process and terminates the present process. In the print process, each print job input by the user, and cleaning based on the execution order and the execution time information of cleaning, which are finally determined in step S309, are executed.

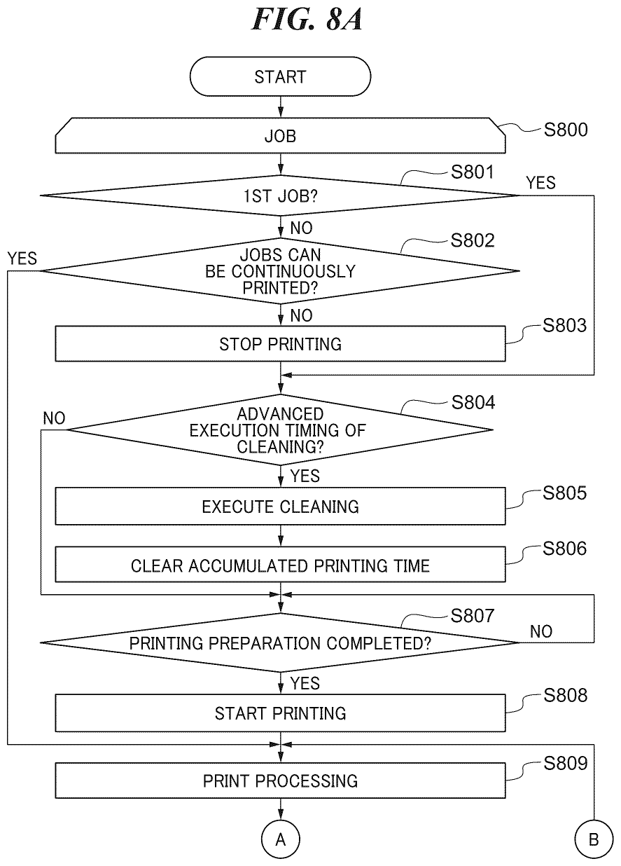

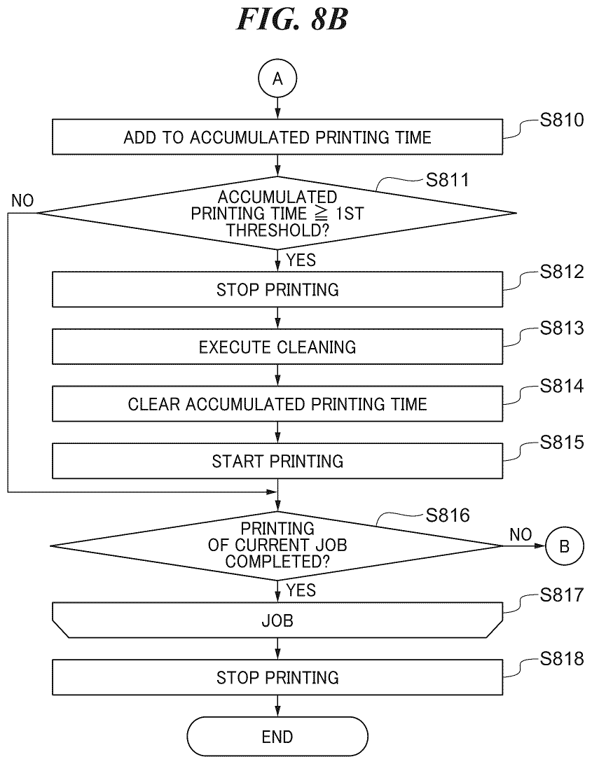

FIGS. 8A and 8B are flowcharts illustrating the print process in the present embodiment. The present process is executed in step S314 in FIGS. 3A and 3B. Steps in FIGS. 8A and 8B are realized by the CPU of the controller 204 of the image forming apparatus 100, which reads an associated program stored in the storage section 205, loads the read program into the RAM, and executes the loaded program. Alternatively, part or all of steps in FIGS. 8A and 8B can be realized by hardware, such as an ASIC and an electronic circuit.

S800 and S817 in FIGS. 8A and 8B indicate that processing operations (steps) between them loop the number of times corresponding to the number of print jobs instructed from a user. First, in step S801, the controller 204 determines whether the current job is the first job instructed from the user. If it is determined by the controller 204 that the current job is the first job (YES in S801), the process proceeds to step S804. If it is determined that the current job is the second or a subsequent job (NO in S801), the process proceeds to step S802. Next, in step S802, the controller 204 determines whether the preceding job and the current job can be continuously printed. If it is determined by the controller 204 that the preceding job and the current job can be continuously printed (YES in S802), the process proceeds to step S809. If it is determined that the preceding job and the current job cannot be continuously printed (NO in S802), the process proceeds to step S803. Note that the method of determining executability of continuous printing is the same as the method used in step S303 in FIGS. 3A and 3B.

Next, in step S803, the controller 204 provides a print stop instruction to the sheet conveying section 201, the image forming section 202, and the fixing section 210, to stop the print processing operation. Next, in step S804, the controller 204 determines whether advanced execution of the periodic cleaning is scheduled at a timing before the current job. If it is determined by the controller 204 that advanced execution of periodic cleaning is scheduled (YES in S804), the process proceeds to step S805. If it is determined that advanced execution of periodic cleaning is not scheduled (NO in s804), the process proceeds to step S807. In step S805, the controller 204 provides an instruction for executing cleaning to the image forming section 202 to execute cleaning of the printer 102. In this cleaning, specifically, the print heads provided with the nozzles for ejecting ink are cleaned (the same operation is performed in a corresponding step, referred to hereinafter).

Next, in step S806, the controller 204 clears the accumulated printing time stored in the storage section 205. Then, in step S807, the controller 204 determines whether printing preparation completion has been detected, and if it is determined by the controller 204 that printing preparation completion has been detected (YES in S807), the process proceeds to step S808. In a case other than this (NO in S807), the controller 204 remains in a waiting state in step S807. That is, if the controller 204 has detected printing preparation completion, the process proceeds to step S808. For example, if it is a timing in which the user replaces the sheet, when completion of replacement of the sheet is detected, printing preparation completion is detected. Next, in step S808, the controller 204 provides a print start instruction to the sheet conveying section 201, the image forming section 202, and the fixing section 210. Then, in step S809, the sheet conveying section 201, the image forming section 202, and the fixing section 210 execute the print processing operation. In the print processing operation, the sheet conveying section 201 conveys the roll sheet 110, and the image forming section 202 controls the printer 102 to perform image formation on the roll sheet 110. The fixing section 210 fixes the formed image by controlling the drying device 105 and the cooling devices 107 and 108 to dry and cool the roll sheet 110.

In step S810, the controller 204 adds the printing time required to perform printing to the accumulated printing time stored in the storage section 205. Next, in step S811, the controller 204 determines whether the accumulated printing time stored in the storage section 205 is greater than or equal to the first threshold value. If it is determined by the controller 204 that the accumulated printing time is greater than or equal to the first threshold value (YES in S811), the process proceeds to step S812. If it is determined that the accumulated printing time is less than the first threshold value (NO in S811), the process proceeds to step S816. In step S812, the controller 204 provides a print stop instruction to the sheet conveying section 201, the image forming section 202, and the fixing section 210, to stop the print processing operation.

In step S813, the controller 204 provides a cleaning execution instruction to the image forming section 202 to execute cleaning of the printer 102. Next, in step S814, the controller 204 clears the accumulated printing time stored in the storage section 205. Then, in step S815, the controller 204 provides a print start instruction to the sheet conveying section 201, the image forming section 202, and the fixing section 210 (start printing).

In step S816, the controller 204 determines whether printing of the current job is completed. This is the last step in the loop indicated by S801 and S817. If it is determined by the controller 204 that printing of the current job is completed (YES in S816), and if the current job is the last print job, the process exits the loop and proceeds to step S818. If it is determined that printing of the current job is not completed (NO in S816), the process remains within the loop and proceeds to step S809. In step S818, the controller 204 provides a print stop instruction to the sheet conveying section 201, the image forming section 202, and the fixing section 210, to stop the print processing operation and terminates the present process.

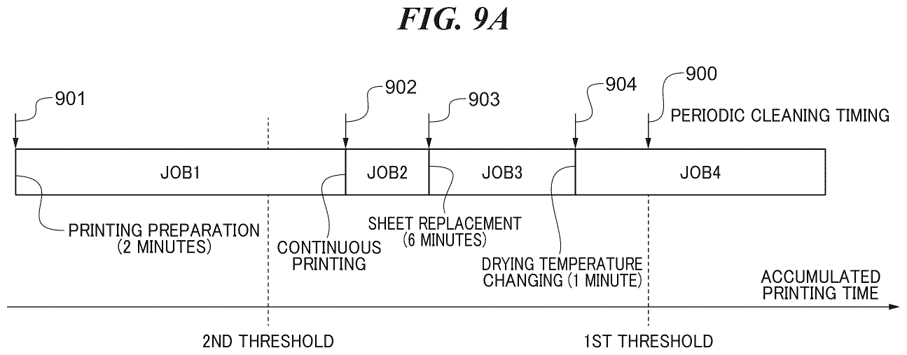

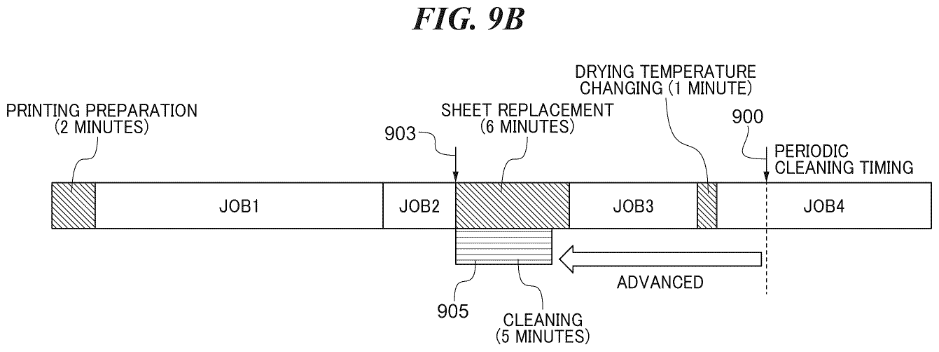

FIG. 9A is a schematic diagram illustrating an example of scheduling of advanced execution of the periodic cleaning in the present embodiment. Laterally long rectangles appearing in FIG. 9A express print jobs instructed from the user. In the direction of the right side in FIG. 9A, the accumulated printing time increases, and the second threshold value and the first threshold value greater than the second threshold value are also illustrated in FIG. 9A. Reference numeral 900 denotes a timing at which the accumulated printing time reaches the first threshold value, i.e. a timing at which execution of the periodic cleaning is scheduled.

Determination on break points 902 to 904 between the jobs is performed by the process in FIGS. 3A and 3B. First, at a printing start point 901, the accumulated printing time is less than the second threshold value, and thus, the printing start point 901 is not set as a periodic cleaning advanced execution timing candidate (NO in S302). Note that immediately after the start of the printing start point 90, it takes two minutes to complete printing preparation (see 600 in FIG. 6).

Next, at a break point 902 between the job 1 and the job 2, the accumulated printing time is less than the first threshold value and is greater than the second threshold value, but the job 1 and the job 2 can be continuously printed to generate no inter-job interruption. Thus, the break point 902 is not set as the periodic cleaning advanced execution timing candidate (YES in S303). At a break point 903 between the job 2 and the job 3, the accumulated printing time is less than the first threshold value but greater than the second threshold value, an inter-job interruption is generated, and thus, the break point 903 is set as a periodic cleaning advanced execution timing candidate (see S304 and S305). Note that inter-job interruption is generated due to sheet replacement, and for example, a job interruption of six minutes is generated (see 602 in FIG. 6).

At a break point 904 between the job 3 and the job 4, the accumulated printing time is less than the first threshold value and greater than the second threshold value, and an inter-job interruption is generated. However, the inter-job interruption time is less than that of the current candidate 903, and thus, the break point 904 is not set as a periodic cleaning advanced execution point candidate (NO in S304). In this example, the inter-job interruption is generated by drying temperature-changing, a time required to change the drying temperature is one minute (see 604 in FIG. 6), which is less than six minutes required to perform sheet replacement. During printing of the job 4, the accumulated printing time becomes greater than the first threshold value and hence the break point 903 between the job 2 and the job 3 as the current candidate at this time point is finally determined as the periodic cleaning advanced execution timing.

FIG. 9B is a schematic diagram illustrating a time schedule in a case where the print processing scheduled in FIG. 9A is executed. Four laterally long rectangles in solid white respectively express the print jobs (job 1 to job 4) instructed from the user. Laterally long rectangles each in a diagonal line pattern express processing executed at an inter-job interruption timing. A laterally long rectangle in a horizontal striped pattern reflects execution of cleaning.

First, after performing the printing preparation operation, the job 1 and the job 2 are continuously printed, and the printing is temporarily stopped at the break point 903 after completion of the job 2. Here, advanced execution of the periodic cleaning is executed in parallel with the user's operation of replacing the sheet (905), and the accumulated printing time is cleared. Then, printing of the job 3 is executed, and the printing is temporarily stopped to change the drying temperature. Printing of the job 4 is then executed to terminate the print processing of all of the jobs.

As described above, in the present embodiment, in the configuration in which the print heads provided with the nozzles for ejecting ink are cleaned, when the accumulated printing time as the printing time accumulated from the latest execution of cleaning reaches the first threshold value, the printing device that executes the periodic cleaning executes the following processing operations: The controller 204 (counting section) counts the accumulated printing time as accumulation of the printing time. Then, in a case where a plurality of print jobs that can be continuously printed exist in a time width of the accumulated printing time, in which the accumulated printing time counted by the counting section is less than the first threshold value and is greater than the second threshold value less than the first threshold value, and a job break point involving printing interruption exists, the following processing operation is executed: The periodic cleaning is advanced and executed at the job break point.

Thus, the periodic cleaning is advanced and executed at a job break point (print interruption point generated due to e.g. sheet replacement) existing within a certain time range before the accumulated printing time reaches a predetermined time period (905). This avoids a situation in which printing is temporarily stopped and the periodic cleaning (900) is executed by interrupting the printing operation. Therefore, it is possible to reduce generation of downtime due to the periodic cleaning as much as possible, while suppressing ink consumption caused by cleaning.

In a case where a plurality of job break points exist, the controller 204 can execute cleaning at a timing at which the inter-job interruption time is longest by advancing the timing of execution thereof and execute cleaning at a timing at which the inter-job interruption time is closest to the first threshold value by advancing the timing of execution thereof. Therefore, the time of advanced execution of the periodic cleaning is sufficiently ensured, and it is also possible to execute cleaning at a timing relatively close to the periodic cleaning by advancing the timing of execution thereof. In a case where the controller 204 executes cleaning by advancing the timing of execution thereof, the user is notified by displaying a notification of the execution order of the print jobs and cleaning (operation of a first notification section) and displaying a notification of a time period required to execute each print job and cleaning (operation of a second notification section). This improves the user-friendliness.

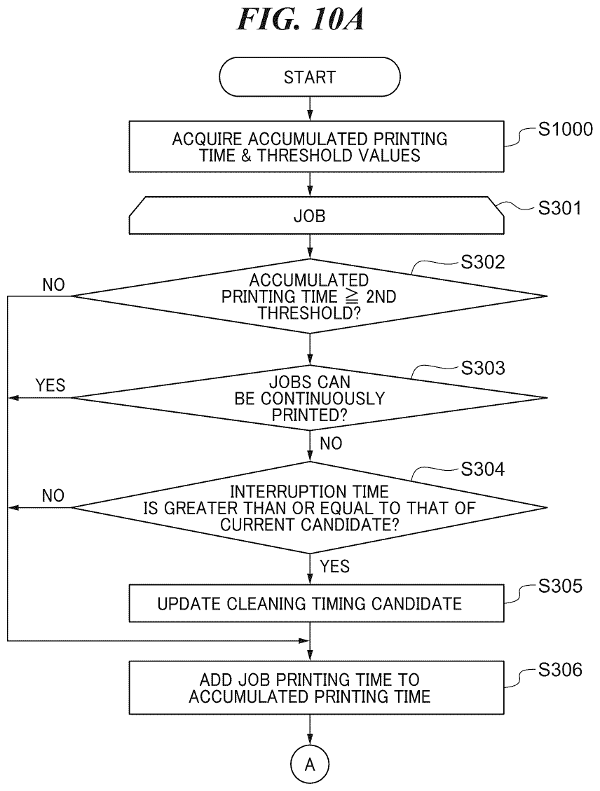

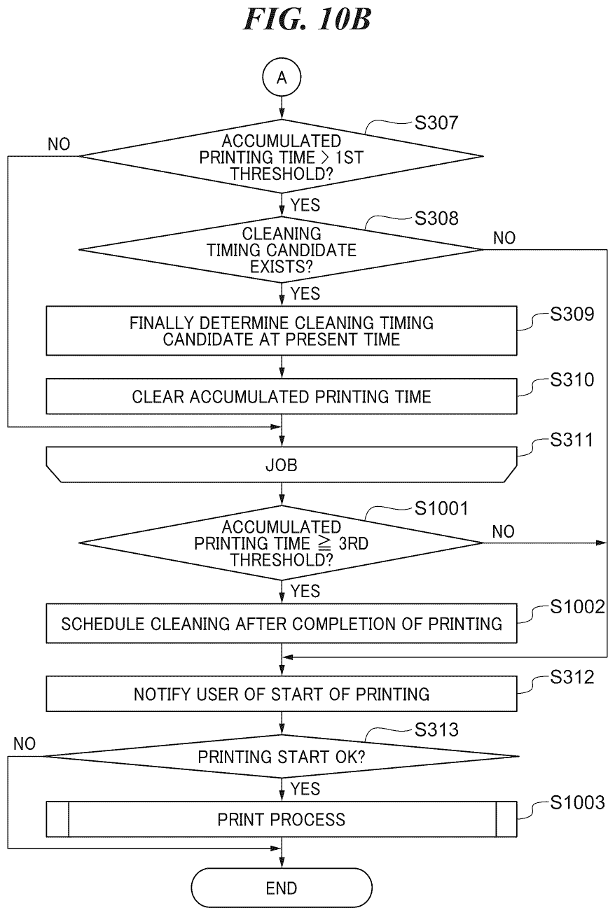

A second embodiment will now be described. In the second embodiment, an aspect in which the periodic cleaning executed at a printing stop timing after all print jobs are finished by advancing the timing of execution of the periodic cleaning will be described with reference to FIGS. 10A, 10B, 11, and 12A and 12B.

FIGS. 10A and 10B are flowcharts of a periodic cleaning advanced execution timing determination process in the second embodiment. Steps in FIGS. 10A and 10B are realized by the CPU of the controller 204 of the image forming apparatus 100, which reads an associated program stored in the storage section 205, loads the read program into the RAM, and executes the loaded program. Alternatively, part or all of steps in FIGS. 10A and 10B can be realized by hardware, such as an ASIC and an electronic circuit. The present process is executed when the user selects a job to be printed and selects the print start button on the UI console panel 101. Note that S301 to S311 in FIGS. 10A and 10B are the same as those denoted by the same numbers in FIGS. 3A and 3B.

First, in step S1000, the controller 204 reads the accumulated printing time into the RAM of the controller 204. The controller 204 reads a first threshold value, a second threshold value, and a third threshold value, used for determination on execution of cleaning, from the storage section 205 onto the RAM. The third threshold value is a value less than the first threshold value and is used for determining whether to perform advanced execution of periodic cleaning at a timing after all print jobs are finished. For example, in a case where the accumulated printing time is greater than or equal to 2 hours 40 minutes when all of the print jobs are finished, the third threshold value is set to 2 hours 40 minutes if it is desired to execute the periodic cleaning by advancing the timing of execution thereof. Note that the third threshold value can be set to the same value as the second threshold value.

Similar to FIGS. 3A and 3B, S301 and S311 indicate that processing operations (steps) between them loop the number of times corresponding to the number of print jobs instructed from a user. In step S302, the controller 204 determines whether the accumulated printing time stored in the RAM is greater than or equal to the second threshold value. If it is determined by the controller 204 that the accumulated printing time is greater than or equal to the second threshold value (YES in S302), the process proceeds to step S303. If it is determined that the accumulated printing time is a value other than this, i.e. is less than the second threshold value (NO), the process proceeds to step S306. Next, in step S303, the controller 204 determines whether the preceding job and the current job can be continuously printed. If it is determined by the controller 204 that the jobs can be continuously printed (YES in S303), the process proceeds to step S306. If it is determined by the controller 204 that the jobs cannot be continuously printed and printing is to be temporarily stopped between the jobs (NO to S303), the process proceeds to step S304. In a case where the current job is the first job as well, the process proceeds to step S304.

In step S304, the controller 204 calculates an inter-job interruption time between the current job and the preceding job and determines whether the calculated inter-job interruption time is greater than or equal to the inter-job interruption time of the current candidate. If it is determined by the controller 204 that the calculated inter-job interruption time is greater than or equal to the inter-job interruption time of the current candidate (YES in S304), the process proceeds to step S305. In a case where no current candidate exists, the process also proceeds to step S305. If it is determined by the controller 204 that the calculated inter-job interruption time is less than the inter-job interruption time of the current candidate (NO in S304), the process proceeds to step S306.

In step S305, the controller 204 executes the processing for updating the cleaning timing candidate. That is, the controller 204 sets the timing between the current job and the preceding job as the “current candidate”. At this time, the controller 204 sets, in a case where the current candidate already exists, the current candidate by overwriting the candidate. Next, in step S306, the controller 204 calculates the printing time of the current job and adds the calculated printing time to the accumulated printing time stored in the RAM. Then, in step S307, the controller 204 determines whether the accumulated printing time stored in the RAM exceeds the first threshold value. If it is determined by the controller 204 that the accumulated printing time exceeds the first threshold value (YES in S307), the process proceeds to step S308. If it is determined that the accumulated printing time does not exceed the first threshold value (NO in S307), the process proceeds to step S311.

In step S308, the controller 204 determines whether the current candidate set in step S305 exists. If it is determined by the controller 204 that the current candidate exists (YES in S308), the process proceeds to step S309. If it is determined that the current candidate does not exist (NO in S308), the process proceeds to step S312. Next, in step S309, the controller 204 determines the current candidate as the current cleaning timing candidate and clears the current candidate. Note that by determining the cleaning timing candidate, the execution order and the execution time information of cleaning are determined. Then, in step S310, the controller 204 clears the accumulated printing time stored in the RAM to 0.

Next, in step S1001, the controller 204 determines whether the accumulated printing time stored in the RAM is greater than or equal to the third threshold value. If it is determined by the controller 204 that the accumulated printing time is greater than or equal to the third threshold value (YES in S1001), the process proceeds to step S1002. If it is determined that the accumulated printing time is less than the third threshold value (NO in S1001), the process proceeds to step S312. Then, in step S1002, the controller 204 schedules advanced execution of the periodic cleaning at a timing after all of the print jobs are finished.

In step S312, the controller 204 sends a display control signal for notifying the user of the start of printing to the display section 206a. The display section 206a performs display processing based on the received display control signal. At this time, similar to the first embodiment, the controller 204 sends the information concerning execution of cleaning to be inserted before the start of printing and between the print jobs. However, the controller 204 does not send the information concerning cleaning to be executed after the printing is terminated. This is because cleaning is executed in parallel with, for example, an operation of removing a print product. Thus the user is not required to be conscious of cleaning. Therefore, in step S1002, the scheduled cleaning execution timing and execution time are not notified (displayed) to the user.

Next, in step S313, the controller 204 determines whether the printing has been started. Specifically, the controller 204 determines whether an operation of selecting the OK button 702 has been detected or an operation of selecting the cancel button 703 has been detected. If it is determined by the controller 204 that the operation of selecting the OK button 702 has been detected (YES in S313), the process proceeds to step S1003. If it is determined that the operation of selecting the cancel button 703 has been detected (NO in S313), the present process is terminated. That is, in a case where the controller 204 detects the operation of the OK button 702, the controller 204 provides a display control instruction to the display section 206a to close the print start confirmation screen 700 and proceeds to step S1003. When the controller 204 detects the operation of the cancel button 703, the controller 204 provides a display control instruction to the display section 206a to close the print start confirmation screen 700 and terminates the present process.

Then, in step S1003, the controller 204 provides a print instruction to the sheet conveying section 201, the image forming section 202, and the fixing section 210 to execute the print process and terminates the present process. In the print process, a print job input by the user and cleaning determined in steps S309 and S1002 are executed.

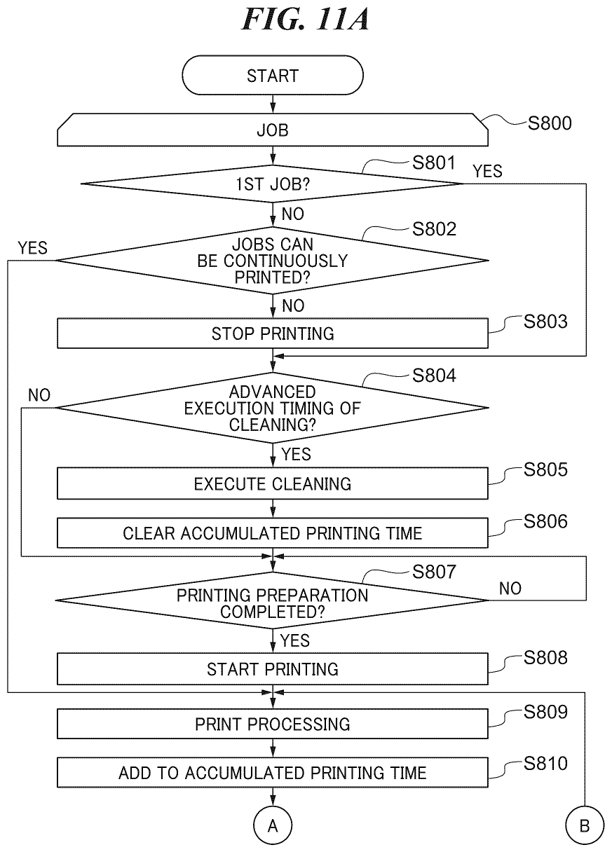

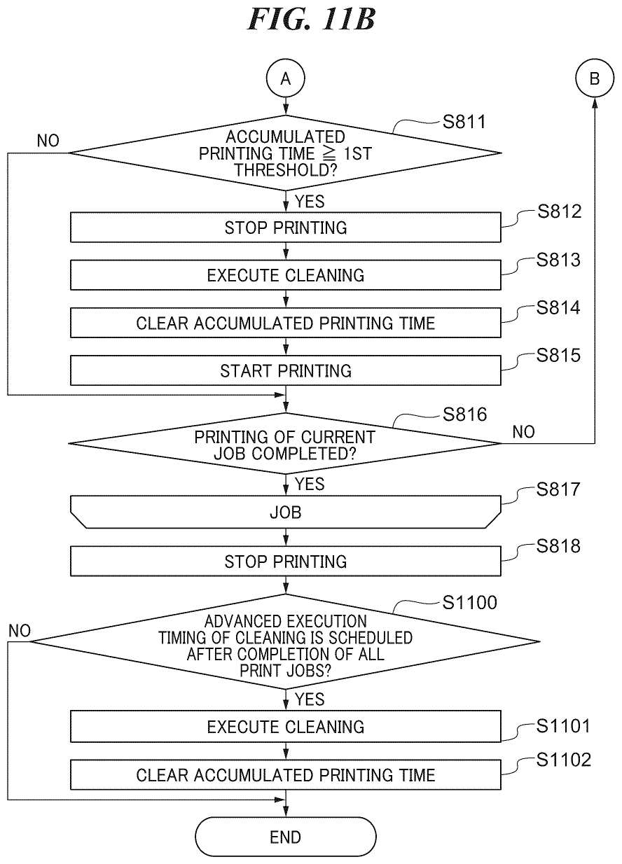

FIGS. 11A-11B illustrates a flowchart of the print process in the second embodiment. The present process is executed in step S1003 in FIGS. 10A-10B. Steps in FIGS. 11A-11B are realized by the CPU of the controller 204 of the image forming apparatus 100, which reads an associated program stored in the storage section 205, loads the read program into the RAM, and executes the loaded program. Alternatively, part or all of steps in FIGS. 11A-11B can be realized by hardware, such as an ASIC and an electronic circuit. Note that step S800 to S818 are the same as those denoted by the same reference numerals in FIGS. 8A and 8B.

S800 and S817 in FIGS. 11A-11B indicate that processing operations (steps) between them loop the number of times corresponding to the number of print jobs instructed from the user. In step S801, the controller 204 determines whether the current job is the first job instructed from the user. If it is determined by the controller 204 that the current job is the first job (YES in S801), the process proceeds to step S804. If it is determined that the current job is the second or a subsequent job (NO in S801), the process proceeds to step S802. Next, in step S802, the controller 204 determines whether the preceding job and the current job can be continuously printed. If it is determined by the controller 204 that the preceding job and the current job can be continuously printed (YES in S802), the process proceeds to step S809. If it is determined that the preceding job and the current job cannot be continuously printed (NO in S802), the process proceeds to step S803.

In step S803, the controller 204 provides a print stop instruction to the sheet conveying section 201, the image forming section 202, and the fixing section 210, to stop the print processing operation. Next, in step S804, the controller 204 determines whether advanced execution of the periodic cleaning is scheduled at a timing before the current job. If it is determined by the controller 204 that advanced execution of periodic cleaning is scheduled (YES in S804), the process proceeds to step S805. If it is determined that advanced execution of periodic cleaning is not scheduled (NO in S804), the process proceeds to step S807. Then, in step S805, the controller 204 provides an instruction for executing cleaning to the image forming section 202 to execute cleaning of the printer 102.

In step S806, the controller 204 clears the accumulated printing time stored in the storage section 205. Next, in step S807, the controller 204 determines whether printing preparation completion has been detected. If printing preparation completion has been detected (YES in S807), the process proceeds to step S808. In a case other than this (NO in S807)), the controller 204 remains in a waiting state in step S807. That is, if the controller 204 has detected printing preparation completion, the process proceeds to step S808. For example, if it is a timing in which the user replaces the sheet, when completion of replacement of the sheet is detected, printing preparation completion is detected. Next, in step S808, the controller 204 provides a print start instruction to the sheet conveying section 201, the image forming section 202, and the fixing section 210. Then, in step S809, the sheet conveying section 201, the image forming section 202, and the fixing section 210 execute print processing.

In step S810, the controller 204 adds the printing time required to perform printing to the accumulated printing time stored in the storage section 205. Next, in step S811, the controller 204 determines whether the accumulated printing time stored in the storage section 205 is greater than or equal to the first threshold value. If it is determined by the controller 204 that the accumulated printing time is greater than or equal to than the first threshold value (YES in S811), the process proceeds to step S812. If it is determined that the accumulated printing time is less than the first threshold value (NO in S811), the process proceeds to step S816. Then, in step S812, the controller 204 provides a print stop instruction to the sheet conveying section 201, the image forming section 202, and the fixing section 210, to stop the print processing operation.

Next, in step S813, the controller 204 provides a cleaning execution instruction to the image forming section 202 to execute cleaning of the printer 102. In step S814, the controller 204 clears the accumulated printing time stored in the storage section 205. In step S815, the controller 204 provides a print start instruction to the sheet conveying section 201, the image forming section 202, and the fixing section 210 (start printing).

Next, in step S816, the controller 204 determines whether printing of the current job is completed. This is the last step in the loop indicated by S801 and S817. If it is determined by the controller 204 that printing of the current job is completed (YES in S816), and if the current job is the last print job, the process exits the loop and proceeds to step S818. If it is determined that printing of the current job is not completed (NO in S816), the process remains within the loop and proceeds to step S809. In step S818, the controller 204 provides a print stop instruction to the sheet conveying section 201, the image forming section 202, and the fixing section 210, to stop the print processing operation.

Next, in step S1100, the controller 204 determines whether advanced execution of the periodic cleaning is scheduled at a timing after all of the print jobs are finished. If it is determined by the controller 204 that advanced execution of the periodic cleaning is scheduled at a timing after all of the print jobs are finished (YES in S1100), the process proceeds to step S1101. If it is determined that advanced execution of the periodic cleaning is not scheduled at a timing after all of the print jobs are finished (NO in S1100), the present process is terminated. Then, in step S1101, the controller 204 provides an instruction for executing cleaning to the image forming section 202 to execute cleaning of the printer 102. In step S1102, the controller 204 clears the accumulated printing time stored in the storage section 205 and terminates the present process.

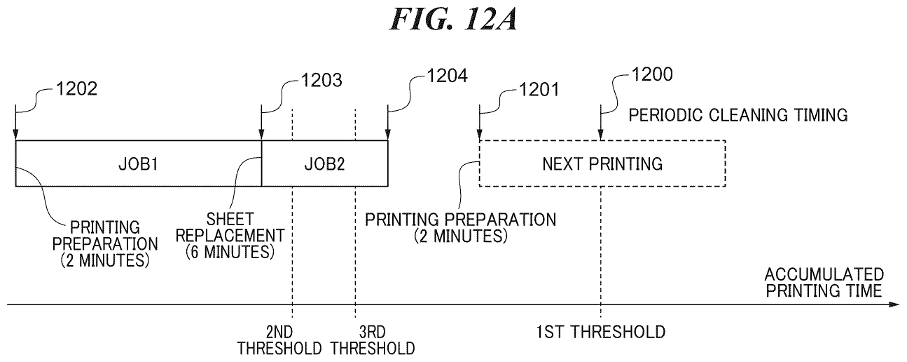

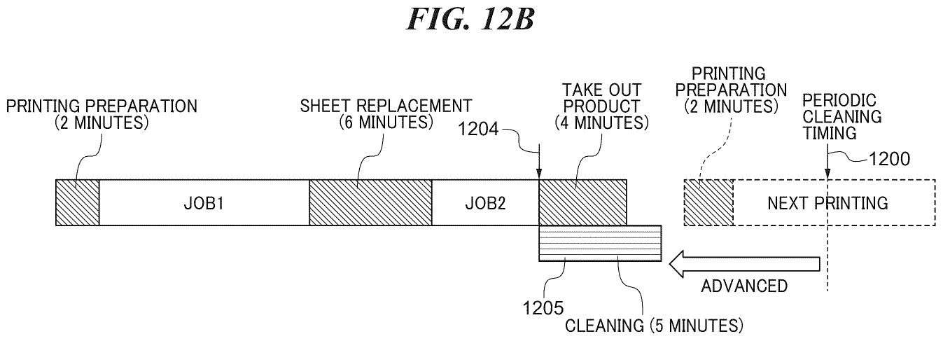

FIG. 12A is a schematic diagram illustrating an example of scheduling of advanced execution of the periodic cleaning in the second embodiment. In the right side in FIG. 12A, the accumulated printing time increases, while the second threshold value, and the third threshold value and the first threshold value, which are larger than the second threshold value, are also illustrated. Reference numeral 1200 denotes a timing at which the accumulated printing time reaches the first threshold value, i.e., a timing at which execution of the periodic cleaning is scheduled. Laterally long rectangles indicated by solid lines reflects print jobs instructed from the user (job 1 and job 2). A laterally long rectangle indicated by a broken line reflects a print job predicted to be instructed next from the user (next printing), and the number of jobs and break points are not determined at this time point. The reference numeral 1200 reflects a timing at which the accumulated printing time reaches the first threshold value, i.e., a periodic cleaning execution scheduled timing, and reference numeral 1201 reflects a timing at which the next printing is started. In a case where the present embodiment is not applied, these timings are set as cleaning execution timing candidates.

By performing the process in FIGS. 10A and 10B, determination on points from 1202 to 1204 is performed. First, at a printing start point 1202, the accumulated printing time is less than the second threshold value, and hence the printing start point 1202 is not set as a periodic cleaning advanced execution timing candidate (NO in S302 in FIGS. 10A and 10B). Next, at a break point 1203 between the job 1 and the job 2, the accumulated printing time is less than the second threshold value, and thus, similarly to the point 1202, the break point 1203 is not set as a periodic cleaning advanced execution timing candidate (NO in S302). Next, at a printing end point 1204, the accumulated printing time is less than the first threshold value but greater than the third threshold value, and thus, the printing end point 1204 is determined as the periodic cleaning advanced execution timing.

FIG. 12B is a schematic diagram illustrating a time schedule in a case where the print processing scheduled in FIG. 12A is executed. Laterally long rectangles in solid white respectively reflect print jobs instructed from the user. Laterally long rectangles each in a diagonal line pattern reflect processing executed at an inter-job interruption timing. A laterally long rectangle in a horizontal striped pattern reflects execution of cleaning.

First, the job 1 is printed after performing the printing preparation operation. After the job 1 is finished, printing is temporarily stopped, and the user performs sheet replacement. Then, printing of the job 2 is executed to complete execution of all the print jobs. At this timing, advanced execution of the periodic cleaning is performed (1204) in parallel with the user's operation of removing the print product, and the accumulated printing time is cleared.

As described above, in the present embodiment, by performing cleaning at a printing end point within a certain time range before the accumulated printing time reaches a predetermined time (1205), it is possible to avoid cleaning from being performed at the next printing start timing or during execution of the next printing. With this, it is possible to reduce generation of downtime due to the periodic cleaning as much as possible while suppressing ink consumption caused by cleaning.

In the second embodiment, the image forming system 200 can be configured to include a notification section that displays, in a case where cleaning is executed by the controller 204 at a time when printing of all print job is finished by advancing the timing of execution of the printing, a notification of only the execution order of the print jobs but does not display a notification of the execution timing of cleaning. Similarly, the image forming system 200 can be configured to include a notification section that displays, in a case where cleaning is executed by the controller 204 at a time when printing of all print job is finished by advancing the timing of execution of the cleaning, a notification only of the printing time of each print job but does not display a notification of the time required to perform cleaning.

As described above, in the present embodiment, in a case where the counted accumulated printing time is less than the first threshold value and is greater than or equal to the third threshold that is less than the first threshold value, at a time when all print jobs are finished, the controller 204 executes the periodic cleaning by advancing the timing of execution thereof at the time when all print jobs are finished.

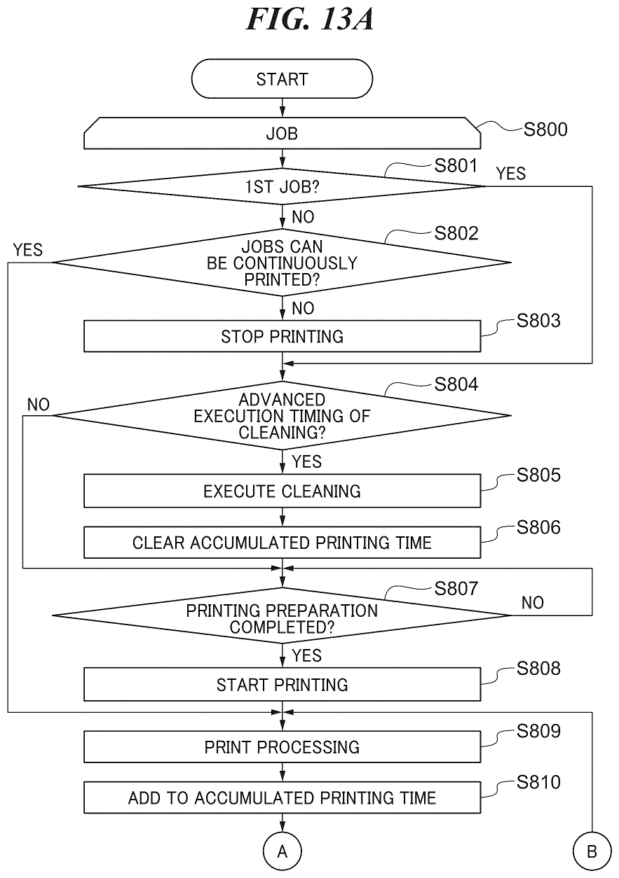

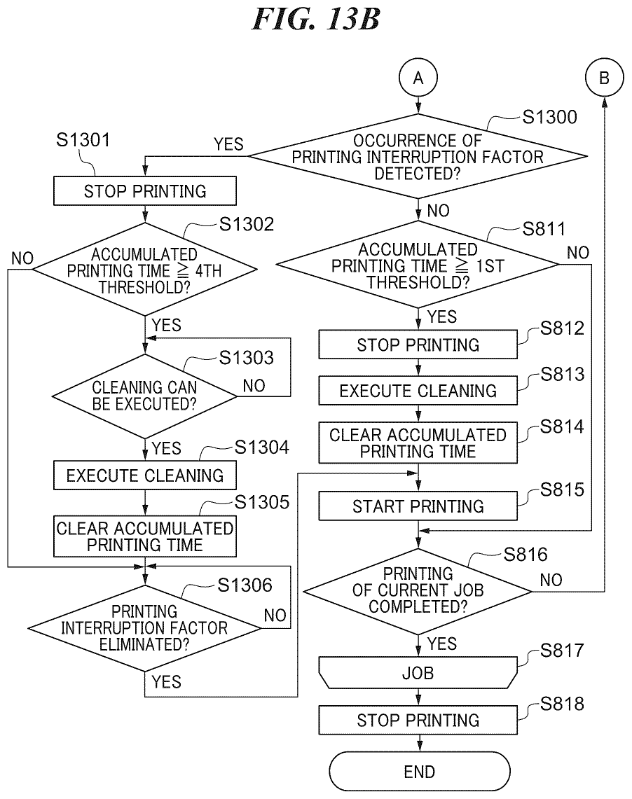

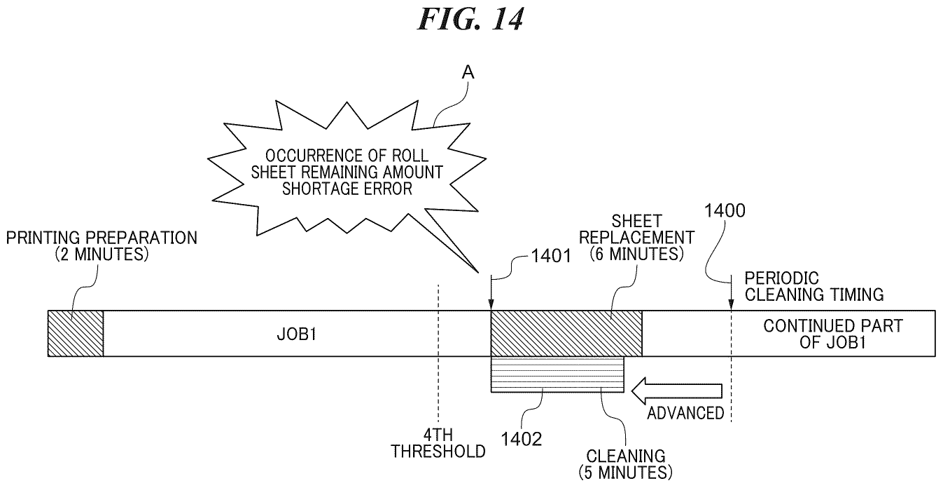

A third embodiment will now be described. In the third embodiment, an aspect in which the periodic cleaning is executed at a timing at which printing is suddenly stopped during printing by advancing the timing of execution of the periodic cleaning will be described with reference to FIGS. 13A, 13B, and 14.

FIGS. 13A and 13B are flowcharts of a print process in the third embodiment. The present process is executed either in a case where the first and second embodiments are not applied, or a case where the first embodiment or the second embodiment is applied, a job break point satisfying conditions is not found, and advanced execution of the periodic cleaning is not scheduled. Steps in FIGS. 13A and 13B are realized by the CPU of the controller 204 of the image forming apparatus 100, which reads an associated program stored in the storage section 205, loads the read program into the RAM, and executes the loaded program. Alternatively, part or all of steps in FIGS. 13A and 13B can be realized by hardware, such as an ASIC and an electronic circuit. Note that S800 to S803 and S807 to S818 are denoted by the same reference numerals in FIGS. 8A and 8B.

S800 and S817 in FIGS. 13A and 13B indicate that processing operations (steps) between them loop the number of times corresponding to the number of print jobs instructed from the user. In step S801, the controller 204 determines whether the current job is the first job instructed from the user. If it is determined by the controller 204 that the current job is the first job (YES in S801), the process proceeds to step S804. If it is determined that the current job is the second or a subsequent job (NO in S801), the process proceeds to step S802. In step S802, the controller 204 determines whether the preceding job and the current job can be continuously printed. If it is determined by the controller 204 that the preceding job and the current job can be continuously printed (YES in S802), the process proceeds to step S809. If it is determined that the preceding job and the current job cannot be continuously printed (NO in S802), the process proceeds to step S803.

In step S803, the controller 204 provides a print stop instruction to the sheet conveying section 201, the image forming section 202, and the fixing section 210 to stop the print processing. Next, in step S804, the controller 204 determines whether advanced execution of the periodic cleaning is scheduled at a timing before the current job. If it is determined by the controller 204 that advanced execution of periodic cleaning is scheduled (YES in S804), the process proceeds to step S805. If it is determined that advanced execution of periodic cleaning is not scheduled (NO in S804), the process proceeds to step S807. Then, in step S805, the controller 204 provides an instruction for executing cleaning to the image forming section 202 to execute cleaning of the printer 102.

Next, in step S806, the controller 204 clears the accumulated printing time stored in the storage section 205. Then, in step S807, the controller 204 determines whether printing preparation completion has been detected, and if it is determined that printing preparation completion has been detected (YES in S807), the process proceeds to step S808. In a case other than this (NO in S807), the controller 204 remains in a waiting state in step S807. That is, if the controller 204 has detected printing preparation completion, the process proceeds to step S808. For example, if it is a timing in which the user replaces the sheet, when completion of replacement of the sheet is detected, printing preparation completion is detected. In step S808, the controller 204 provides a print start instruction to the sheet conveying section 201, the image forming section 202, and the fixing section 210. Next, in step S809, the sheet conveying section 201, the image forming section 202, and the fixing section 210 execute print processing. Then, in step S810, the controller 204 adds the printing time required to perform printing to the accumulated printing time stored in the storage section 205.

Next, in step S1300, the controller 204 determines whether generation of a sudden printing interruption factor has been detected. If the controller 204 has detected a sudden printing interruption factor (YES in S1300), the process proceeds to step S1301. If no sudden printing interruption factor has been detected (NO in S1300), the process proceeds to step S811. The sudden printing interruption factor refers to, for example, a roll sheet remaining amount shortage error caused when the remaining amount of the roll sheet 110 is insufficient and a waste ink tank full error caused when the available capacity of the waste ink tank is insufficient.

Next, in step S1301, the controller 204 provides a print stop instruction to the sheet conveying section 201, the image forming section 202, and the fixing section 210, to stop the print processing. Then, in step S1302, the controller 204 determines whether the accumulated printing time stored in the storage section 205 is greater than or equal to a fourth threshold value. If it is determined by the controller 204 that the accumulated printing time is greater than or equal to the fourth threshold value (YES in S1302), the process proceeds to step S1303. If it is determined that the accumulated printing time is less than the fourth threshold value (NO in S1302), the process proceeds to step S1306. The fourth threshold value is a value less than the first threshold value and is used for determination of whether to execute the periodic cleaning at a timing at which printing is suddenly stopped during printing by advancing the timing of execution of the periodic cleaning. For example, in a case where the accumulated printing time is greater than or equal to 2 hours 50 minutes at a time when printing is suddenly stopped during printing, if it is desired to execute the periodic cleaning by advancing the timing of execution of thereof, the fourth threshold value is set to 2 hours 50 minutes. The fourth threshold value is stored in the storage section 205. The fourth threshold value can be set to the same value as the second threshold value or the third threshold value.

In step S1303, the controller 204 determines whether the image forming system 200 is in a cleaning executable state, and if it is determined that the image forming system 200 is in the cleaning executable state (YES in S1303), the process proceeds to step S1304. If it is determined by the controller 204 that the image forming system 200 is not in the cleaning executable state (NO in S1303), the controller 204 remains in a waiting state in step S1303. In a case where the controller 204 can determine that the image forming system 200 is in the cleaning executable state, the process leaves step S1303 and proceeds to step S1304. For example, if the printing interruption factor is the roll sheet remaining amount shortage error, cleaning can be executed in parallel with the user's operation of performing sheet replacement, and thus, the controller 204 determines that the image forming system 200 is in the cleaning executable state. If the printing interruption factor is the waste ink tank full error, cleaning cannot be executed unless the waste ink tank has an available capacity, and thus, after the user disposes waste ink to make an available capacity in the waste ink tank, the controller 204 detects that the image forming system 200 is in the cleaning executable state.

In step S1304, the controller 204 provides an instruction for executing cleaning to the image forming section 202 to execute cleaning of the printer 102. Then, in step S1305, the controller 204 clears the accumulated printing time stored in the storage section 205. Next, in step S1306, the controller 204 determines whether elimination of the printing interruption factor has been detected. If it is determined by the controller 204 that elimination of the printing interruption factor has been detected (YES in S1306), the process proceeds to step S815. If it is determined that elimination of the printing interruption factor has not been detected (NO in S1306), the controller 204 remains in a waiting state in step S1306 until elimination of the printing interruption factor is detected. Elimination of the printing interruption factor refers to completion of sheet replacement if the printing interruption factor is the roll sheet remaining amount shortage error, and generation of an available capacity in the waste ink tank if the printing interruption factor is the waste ink tank full error.

In step S811, the controller 204 determines whether the accumulated printing time stored in the storage section 205 is greater than or equal to the first threshold value. If it is determined by the controller 204 that the accumulated printing time is greater than or equal to the first threshold value (YES in S811), the process proceeds to step S812. If it is determined that the accumulated printing time is less than the first threshold value (NO), the process proceeds to step S816. In step S812, the controller 204 provides a print stop instruction to the sheet conveying section 201, the image forming section 202, and the fixing section 210, to stop the print processing. Next, in step S813, the controller 204 provides a cleaning execution instruction to the image forming section 202 to execute cleaning of the printer 102. Then, in step S814, the controller 204 clears the accumulated printing time stored in the storage section 205.

In step S815, the controller 204 provides a print start instruction to the sheet conveying section 201, the image forming section 202, and the fixing section 210. Next, in step S816, the controller 204 determines whether printing of the current job is completed. This is the last step in the loop indicated by S801 and S817. If it is determined by the controller 204 that printing of the current job is completed (YES in S816), and if the current job is the last print job, the process exits the loop and proceeds to step S818. If it is determined that printing of the current job is not completed (NO in S816), the process remains within the loop and proceeds to step S809. In step S818, the controller 204 provides a print stop instruction to the sheet conveying section 201, the image forming section 202, and the fixing section 210, to stop the print processing operation and terminates the present process.

FIG. 14 is a schematic diagram illustrating a time schedule in a case where the print process in the third embodiment is executed. Laterally long rectangles in solid white reflect a print job instructed from the user (job 1 and continuation of the job 1). Laterally long rectangles each in a diagonal line pattern reflect processing executed at an inter-job interruption timing. A laterally long rectangle in a horizontal striped pattern reflects execution of cleaning.

Reference numeral 1400 denotes a timing at which the accumulated printing time reaches the first threshold value, i.e. a timing at which execution of the periodic cleaning is scheduled. First, printing of the job 1 is executed after performing the printing preparation operation. A roll sheet remaining amount shortage error occurs (see A) at a timing (1401) after the accumulated printing time counted during printing is longer than the fourth threshold value, and hence the printing is temporarily interrupted. At this time, advanced execution of the periodic cleaning (1402) is performed in parallel with a user's operation of sheet replacement (printing is interrupted for six minutes in the illustrated example in FIG. 14), and the accumulated printing time is cleared. Then, printing of the continued part of the job 1 is executed to complete all of the print job.

As described above, in the present embodiment, in a case where a printing interruption factor that interrupts printing during execution of a print job occurs, the following processing is performed: In a case where the accumulated printing time counted by the counting section (controller 204) is less than the first threshold value and is greater than or equal to the fourth threshold value less than the first threshold value at a time point of occurrence of a printing interruption factor, the periodic cleaning is executed by advancing the timing of execution thereof at the time of occurrence of the printing interruption factor. Thus, in the third embodiment, the periodic cleaning is executed by advancing the timing of execution thereof at a timing (1402) at which the “printing interruption factor” (mark A) occurs within a certain time range before the accumulated printing time reaches a predetermined time (first threshold value). This enables avoiding temporarily stopping printing to execute the periodic cleaning during printing. As a result, it is possible to reduce generation of downtime due to the periodic cleaning as much as possible while suppressing ink consumption caused by cleaning.

While in the above-described embodiments, the image forming system 200 has been discussed by way of example, in a case where the accumulated printing time of a multifunction peripheral (MFP), an inkjet printer for home use or business use, or the like reaches a certain threshold value, if it is a printing device that executes periodic cleaning of print heads, the present disclosure can be applied.

The controller 204 can display the information of print jobs, the execution order, and the required time of cleaning, as illustrated in FIG. 7, on a display screen of a mobile terminal, such as a smartphone, a tablet terminal, and a laptop-type PC, by using the communication section 203. To achieve this, it is only needed for a dedicated application to be downloaded from a specific site and installed in the mobile terminal in advance.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-205197 filed Dec. 5, 2023, which is hereby incorporated by reference herein in its entirety.

What is claimed is:

1. A printing device configured to clean print heads provided with a nozzle for ejecting ink and execute periodic cleaning when accumulated printing time as printing time accumulated from the latest execution of cleaning reaches a first threshold value, the printing device comprising:
at least one processor; and
at least one memory, in communication with the at least one processor, storing a program that, when executed by the processor, causes the processor to:
count accumulated printing time obtained by accumulating printing time; and
execute, when there is a job break point involving printing interruption in a case where there are a plurality of print jobs that can be continuously printed in a time width of the accumulated printing time in which the counted accumulated printing time is less than the first threshold value and is greater than or equal a second threshold value less than the first threshold value, the periodic cleaning at the job break point by advancing timing of execution of the periodic cleaning.

2. The printing device according to claim 1, wherein in a case where a plurality of the job break points exist, the processor further executes the periodic cleaning at a job break point where a printing interruption time is longest by advancing timing of execution of the periodic cleaning.

3. The printing device according to claim 1, wherein in a case where a plurality of the job break points exist, the processor further executes the periodic cleaning at a job break point where a printing interruption time is closest to the first threshold value by advancing timing of execution of the periodic cleaning.

4. The printing device according to claim 1, wherein the plurality of print jobs which can be continuously printed include a preceding job temporally earlier than a current job, and wherein the plurality of print jobs are the same in a sheet setting, a sheet conveying speed, or a sheet drying temperature.

5. The printing device according to claim 1, wherein the processor display a notification of an execution order of each print job and cleaning in a case where the periodic cleaning is executed by advancing timing of execution thereof.

6. The printing device according to claim 1, wherein the processor displays a notification of time periods required to respectively execute each print job and cleaning in a case where the periodic cleaning is executed by advancing timing of execution of the periodic cleaning.

7. The printing device according to claim 6, wherein the processor displays a notification of only printing time of each print job and does not display a notification of time required to execute cleaning, in a case where the periodic cleaning is executed at the time when all print jobs are finished by advancing timing of execution of the periodic cleaning.

8. The printing device according to claim 1, wherein in a case where the counted accumulated printing time is less than the first threshold value and is greater than or equal a third threshold value less than the first threshold value at a time when all the print jobs are finished, the processor executes the periodic cleaning at the time when all the print jobs are finished, by advancing timing of execution of the periodic cleaning.

9. The printing device according to claim 8, wherein, in a case where the periodic cleaning is executed at the time when all print jobs are finished by advancing timing of execution of the periodic cleaning, the processor displays a notification of only an execution order of each print job and does not display a notification of an execution timing of cleaning.

10. The printing device according to claim 1, wherein in a case where a printing interruption factor that causes interruption of printing occurs during execution of a print job, the processor executes the periodic cleaning at a time of occurrence of the printing interruption factor by advancing timing of execution of the periodic cleaning, in a case where the counted accumulated printing time is less than the first threshold value and is greater than or equal a fourth threshold value smaller than the first threshold value.

11. The printing device according to claim 10, wherein the printing interruption factor is a roll sheet remaining amount shortage error occurring when a remaining amount of roll sheet as a printing medium is insufficient or a waste ink tank full error occurring when an available capacity of a waste ink tank is insufficient.

12. A method of controlling a printing device configured to clean print heads provided with a nozzle for ejecting ink and execute periodic cleaning when accumulated printing time as printing time accumulated from the latest execution of cleaning reaches a first threshold value, the method comprising:
counting accumulated printing time obtained by accumulating printing time; and
executing, when there is a job break point involving printing interruption in a case where there are a plurality of print jobs that can be continuously printed in a time width of the accumulated printing time in which the counted accumulated printing time is less than the first threshold value and is greater than or equal to a second threshold value less than the first threshold value, the periodic cleaning at the job break point by advancing timing of execution of the periodic cleaning.

13. A non-transitory computer-readable storage medium storing a program for causing a computer to execute a method of controlling a printing device configured to clean print heads provided with a nozzle for ejecting ink and execute periodic cleaning when accumulated printing time as printing time accumulated from the latest execution of cleaning reaches a first threshold value, the method comprising:
counting accumulated printing time obtained by accumulating printing time; and
executing, when there is a job break point involving printing interruption in a case where there are a plurality of print jobs that can be continuously printed in a time width of the accumulated printing time in which the counted accumulated printing time is less than the first threshold value and is greater than or equal to a second threshold value less than the first threshold value, the periodic cleaning at the job break point by advancing timing of execution of the periodic cleaning.
